(19) United States
(12) Patent Application Publication
(10) Pub. No.: US 2019/0147399 A1
(43) Pub. Date: May 16, 2019

(54) SYSTEM AND METHOD FOR VEHICLE DISPATCH

(71) Applicant: Chorus Logistics, LLC, Houston, TX (US)

(72) Inventor: Jeff O'BLOCK, Houston, TX (US)

(73) Assignee: Chorus Logistics, LLC, Houston, TX (US)

(21) Appl. No.: 16/185,854

(22) Filed: Nov. 9, 2018

Related U.S. Application Data
(60) Provisional application No. 62/587,260, filed on Nov. 16, 2017.
(60) Provisional application No. 62/584,355, filed on Nov. 10, 2017.

(51) Int. Cl. G06Q 10/08; H04W 4/40; G06Q 10/06; G06Q 40/00

(52) U.S. Cl. CPC G06Q 10/0834; H04W 4/40; G06Q 10/0833; G06Q 10/06315; G06Q 40/10; G06Q 10/08355

(57) ABSTRACT

Some embodiments provide a method for commercial vehicle dispatch for transportation of a product. In some embodiments, the method includes receiving an order request for the product from an order entry client, determining a product condition, and determining a vehicle condition of a first commercial vehicle and a vehicle condition of a second commercial vehicle. In some embodiments, the method further includes identifying, based on the product condition and the vehicle condition of the first commercial vehicle and the vehicle condition of the second commercial vehicle, an optimal commercial vehicle, the optimal commercial vehicle being either the first commercial vehicle or the second commercial vehicle. In some embodiments, the method further includes assigning the order request to the optimal commercial vehicle, and transmitting, to the optimal commercial vehicle, the order request.

### CLAIM OF PRIORITY AND CROSS-REFERENCE TO RELATED APPLICATIONS

This Application claims the benefit of U.S. Provisional Application Ser. No. 62/587,260 filed Nov. 16, 2017 titled “System and Method for Vehicle Dispatch,” and U.S. Provisional Application Ser. No. 62/584,355 filed Nov. 10, 2017 titled “System and Method for Vehicle Dispatch.” The provisional applications are incorporated by reference herein as if reproduced in full below.

### BACKGROUND

The present invention relates to a dispatch system for commercial vehicles.

### SUMMARY

Some products, for instance petroleum products, originate from multiple locations and are delivered to multiple end points. To accomplish the delivery of such products, multiple independent commercial vehicles may be used.

Such products must be delivered in a timely manner but may need to be in compliance with applicable safety regulations. Manual scheduling techniques, which rely heavily on human operators reporting their status and other information may not be sufficient or accurate enough to accomplish this. Accordingly, systems and methods are presented herein for commercial vehicle dispatching.

One embodiment described herein provides a commercial vehicle dispatch system for transportation of a product, the system comprising a first commercial vehicle, a second commercial vehicle, an order entry client, and a dispatch server. The dispatch server is configured to receive an order request for the product from the order entry client, determine a product condition, determine a vehicle condition of the first commercial vehicle and a vehicle condition of the second commercial vehicle, and identify, based on the product condition and the vehicle condition of the first commercial vehicle and the vehicle condition of the second commercial vehicle, an optimal commercial vehicle, the optimal commercial vehicle being either the first commercial vehicle or the second commercial vehicle. The dispatch server is further configured to assign the order request to the optimal commercial vehicle and transmit, to the optimal commercial vehicle, the order request.

Another example embodiment provides a method for commercial vehicle dispatching for transportation of a product. The method includes receiving an order request for the product from an order entry client, determining a product condition, determining a vehicle condition of a first commercial vehicle and a vehicle condition of a second commercial vehicle, and identifying, based on the product condition and the vehicle condition of the first commercial vehicle and the vehicle condition of the second commercial vehicle, an optimal commercial vehicle, the optimal commercial vehicle being either the first commercial vehicle or the second commercial vehicle. The method further includes assigning the order request to the optimal commercial vehicle and transmitting, to the optimal commercial vehicle, the order request.

Another example embodiment provides a commercial vehicle dispatch server for transportation of a product. The server is configured to receive an order request for the product from an order entry client, determine a product condition, and determine a vehicle condition of a first commercial vehicle and a vehicle condition of a second commercial vehicle. The server is also configured to identify, based on the product condition and the vehicle condition of the first commercial vehicle and the vehicle condition of the second commercial vehicle, an optimal commercial vehicle, the optimal commercial vehicle being either the first commercial vehicle or the second commercial vehicle, assign the order request to the optimal commercial vehicle, and transmit, to the optimal commercial vehicle, the order request. The server is also configured to monitor and verify a performance of the optimal commercial vehicle while the optimal commercial vehicle is assigned the order request and unassign the order request from the optimal commercial vehicle when the optimal commercial vehicle fails to comply with the product condition after a predetermined period of time.

Another example embodiment provides a commercial vehicle dispatch system for transportation of a product. The system includes a plurality of commercial vehicles, an order entry client, and a dispatch server. The dispatch server is configured to receive an order request for the product from the order entry client, determine a safety condition based on the product, and determine, based on the safety condition of the product, at least one of an optimal commercial vehicle from the plurality of commercial vehicles, wherein the at least one optimal commercial vehicle complies with the safety condition. The dispatch server is also configured to assign the order request to the optimal commercial vehicle and transmit, to the optimal commercial vehicle, the order request.

Another example embodiment provides a method for a commercial vehicle dispatch system for transportation of a product. The method includes receiving an order request for the product from an order entry client, determining a safety condition based on the product, and determining, based on the safety condition of the product, at least one of an optimal commercial vehicle from the plurality of commercial vehicles, wherein the at least one optimal commercial vehicle complies with the safety condition. The method also includes assigning the order request to the optimal commercial vehicle, and transmitting, to the optimal commercial vehicle, the order request.

Another example embodiment provides a commercial vehicle dispatch server for transportation of a product. The server is configured to receive an order request for the product from an order entry client, determine a safety requirement condition based on the product, and determine, based on the safety condition of the product, at least one of an optimal commercial vehicle from the plurality of commercial vehicles, wherein the at least one optimal commercial vehicle complies with the safety condition. The server is also configured to assign the order request to the optimal commercial vehicle, transmit, to the optimal commercial vehicle, the order request, execute, and, after transmitting the order request to the optimal commercial vehicle, a verification action. The verification action is used to verify that the optimal commercial vehicle maintains an order request compliance while the optimal commercial vehicle is assigned the order request. The server is also configured to determine, based on the verification action, whether the optimal commercial vehicle is maintaining the order request compliance, in response to the optimal commercial vehicle failing to maintain the order request compliance, and transmit a warning notice to a driver of the optimal commercial vehicle. The server is further configured to, after transmitting the warning notice and if the optimal commercial vehicle continues to fail to maintain the order request compliance, perform at least one selected from the group consisting of denying submission of an invoice and unassigning the order request from the optimal commercial vehicle.

Another example embodiment provides a commercial vehicle dispatch system for transportation of a product. The system includes an order entry client and a dispatch server. The dispatch server is configured to receive an order request for the product from the order entry client, the order request including a destination of the product, assign a commercial vehicle to complete the order request, and determine, based on an initial location of the product or the commercial vehicle and the destination of the product, a plurality of possible routes to the destination. The dispatch server is also configured to determine a lowest cost route from the plurality of possible routes based on a route cost, assign the lowest cost route to the commercial vehicle, and verify that the commercial vehicle is following the lowest cost route while the commercial vehicle is assigned the order request by monitoring a location of the commercial vehicle and comparing the location to the lowest cost route.

Another example embodiment provides a method for dispatching a commercial vehicle for transportation of a product. The method includes receiving an order request for the product from an order entry client, the order request including a destination of the product, assigning a commercial vehicle to complete the order request, and determining, based on an initial location of the product or the commercial vehicle and the destination of the product, a plurality of possible routes to the destination. The method also includes determining a lowest cost route from the plurality of possible routes based on a route cost, assigning the lowest cost route to the commercial vehicle, verifying that the commercial vehicle is following the lowest cost route while the commercial vehicle is assigned the order request by monitoring a location of the commercial vehicle, and comparing the location to the lowest cost route.

Another example embodiment provides a commercial vehicle dispatch server for transportation of a product. The server is configured to receive an order request for the product from an order entry client, the order request including a destination of the product, assign a commercial vehicle to complete the order request, and determine, based on an initial location of the product or the commercial vehicle and the destination of the product, a plurality of possible routes to the destination. The server is also configured to determine a lowest cost route from the plurality of possible routes based on a route cost, assign the lowest cost route to the commercial vehicle, and verify that the commercial vehicle is following the lowest cost route while the commercial vehicle is assigned the order request by monitoring a location of the commercial vehicle and comparing the location to the lowest cost route. The server is also configured to calculate, after completion of the order request, a tax rebate based on an actual route of the commercial vehicle, generate, based on the tax rebate, an invoice for the order request, and transmit, when the commercial vehicle fails to follow the lowest cost route, a warning notice. The server is further configured to after transmitting the warning notice and the commercial vehicle continues to fail to follow the lowest cost route, perform at least one selected from the group consisting of denying submission of the invoice and unassigning the order request from the commercial vehicle.

Other aspects of the invention will become apparent by consideration of the detailed description and accompanying drawings.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 illustrates a vehicle dispatch system according to some embodiments.

FIG. 2 illustrates a dispatch server of the system of FIG. 1 according to some embodiments.

FIG. 3 illustrates an electronic computing device according to some embodiments.

FIG. 4 is a flow diagram illustrating a method of commercial vehicle dispatching for transportation of a product according to some embodiments.

FIG. 5A is a flow diagram illustrating a method of commercial vehicle dispatching for maintaining a safety compliance of a product according to some embodiments.

FIG. 5B is a flow diagram illustrating a method of commercial vehicle dispatching for maintaining a safety compliance of a product according to some embodiments.

FIG. 6 is a flow diagram illustrating a method of commercial vehicle dispatching for determining and verifying the optimal commercial vehicle follows the lowest cost route according to some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The device and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

Reference will now be made in detail to embodiments, examples of which are illustrated in the accompanying drawings. In the following detailed description, numerous specific details are set forth in order to provide a thorough understanding of the present disclosure. However, it will be apparent to one of ordinary skill in the art that some embodiments may be practiced without these specific details. In other instances, well-known methods, procedures, components, circuits, and networks have not been described in detail so as not to unnecessarily obscure aspects of the embodiments.

It will also be understood that, although the terms first, second, etc. may be used herein to describe various elements, these elements should not be limited by these terms. These terms are only used to distinguish one element from another. For example, a first contact could be termed a second contact, and, similarly, a second contact could be termed a first contact, without departing from the intended scope. The first contact and the second contact are both contacts, but they are not the same contact.

The terminology used in the description herein is for the purpose of describing particular embodiments only and is not intended to be limiting. As used in the description and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

Some embodiments include a commercial vehicle dispatch server for transportation of a product. In some embodiments the server is configured to receive an order request for the product from an order entry client, determine a product condition, and determine a vehicle condition of a first commercial vehicle and a vehicle condition of a second commercial vehicle. In some embodiments the server is configured to identify, based on the product condition and the vehicle condition of the first commercial vehicle and the vehicle condition of the second commercial vehicle, an optimal commercial vehicle, the optimal commercial vehicle being either the first commercial vehicle or the second commercial vehicle. In some embodiments the server is configured to assign the order request to the optimal commercial vehicle, transmit, to the optimal commercial vehicle, the order request, and monitor and verify a performance of the optimal commercial vehicle while the optimal commercial vehicle is assigned the order request. In some embodiments the server is configured to unassign the order request from the optimal commercial vehicle when the optimal commercial vehicle fails to comply with the product condition after a predetermined period of time.

Some embodiments include a commercial vehicle dispatch server for transportation of a product. In some embodiments, the server is configured to receive an order request for the product from an order entry client, determine a safety requirement condition based on the product, and determine, based on the safety condition of the product, at least one of an optimal commercial vehicle from the plurality of commercial vehicles, wherein the at least one optimal commercial vehicle complies with the safety condition. In some embodiments, the server is configured to assign the order request to the optimal commercial vehicle, transmit, to the optimal commercial vehicle, the order request, and execute, after transmitting the order request to the optimal commercial vehicle, a verification action. In some embodiments, the verification action is used to verify that the optimal commercial vehicle maintains an order request compliance while the optimal commercial vehicle is assigned the order request. In some embodiments, the server is configured to determine, based on the verification action, whether the optimal commercial vehicle is maintaining the order request compliance. In some embodiments, the server is configured to, in response to the optimal commercial vehicle failing to maintain the order request compliance, transmit a warning notice to a driver of the optimal commercial vehicle, and, after transmitting the warning notice and if the optimal commercial vehicle continues to fail to maintain the order request compliance, perform at least one selected from the group consisting of denying submission of an invoice and unassigning the order request from the optimal commercial vehicle. In some embodiments, the dispatch server is further configured to recurrently assign the order request via a duplicate order request to a second optimal commercial vehicle.

Some embodiments include commercial vehicle dispatch server for transportation of a product. In some embodiments, the server is configured to receive an order request for the product from an order entry client, the order request including a destination of the product, assign a commercial vehicle to complete the order request, determine, based on an initial location of the product or the commercial vehicle and the destination of the product, a plurality of possible routes to the destination, and determine a lowest cost route from the plurality of possible routes based on a route cost. In some embodiments, the server is configured to assign the lowest cost route to the commercial vehicle, verify that the commercial vehicle is following the lowest cost route while the commercial vehicle is assigned the order request by monitoring a location of the commercial vehicle and comparing the location to the lowest cost route, and calculate, after completion of the order request, a tax rebate based on an actual route of the commercial vehicle. In some embodiments, the server is configured to generate, based on the tax rebate, an invoice for the order request, transmit, when the commercial vehicle fails to follow the lowest cost route, a warning notice, and, after transmitting the warning notice and the commercial vehicle continues to fail to follow the lowest cost route, perform at least one selected from the group consisting of denying submission of the invoice and unassigning the order request from the commercial vehicle.

Some embodiments include a commercial vehicle dispatch system for transportation of a product. In some embodiments, the product is a liquid. In some embodiments, the liquid is unrefined petroleum. In some embodiments, the system includes a first commercial vehicle and a second commercial vehicle acting in response to orders from an order entry client in response to a dispatch server. In some embodiments, the dispatch server is configured to receive an order request for the product from the order entry client, determine a product condition, and determine a vehicle condition of the first commercial vehicle and a vehicle condition of the second commercial vehicle. In some embodiments, the dispatch server is configured to identify, based on the product condition and the vehicle condition of the first commercial vehicle and the vehicle condition of the second commercial vehicle, an optimal commercial vehicle, the optimal commercial vehicle being either the first commercial vehicle or the second commercial vehicle. In some embodiments, the dispatch server is configured to assign the order request to the optimal commercial vehicle, and transmit, to the optimal commercial vehicle, the order request.

In some embodiments, the dispatch server is further configured to receive, from the optimal commercial vehicle, an order request deferral, in response to the order request deferral, identify a second optimal commercial vehicle, reassign the order request to the second optimal commercial vehicle, and transmit, to the second optimal commercial vehicle, the order request.

In some embodiments, the vehicle condition of the first commercial vehicle and the vehicle condition of the second commercial vehicle are each at least one selected from the group consisting of a physical rating, a rate of charge, a current location, a telecommunication provider, past performance data, and equipment data.

In some embodiments, the product condition includes at least one selected from the group consisting of a delivery time window, a pick-up time window, an equipment constraint, and a storage constraint.

In some embodiments, the dispatch server is further configured to monitor and verify a performance of the optimal commercial vehicle while the optimal commercial vehicle is assigned the order request.

In some embodiments, the dispatch server is further configured to unassign the order request from the optimal commercial vehicle when the optimal commercial vehicle fails to comply with the product condition after a predetermined period of time.

In some embodiments, the dispatch system further includes a vehicle trailer/tank database, wherein the vehicle trailer/tank database includes information regarding a trailer or tank of the first commercial vehicle and a trailer or tank of the second commercial vehicle.

In some embodiments, the information includes at least one selected from the group consisting of a trailer or tank content history, a gauge measurement of a tank, a location of the tank or trailer, and data regarding a product stored in the tank or trailer.

In some embodiments, the dispatch server is further configured to receive and verify a location of the optimal commercial vehicle while the optimal commercial vehicle is assigned the order request.

In some embodiments the dispatch server is further configured to recurrently assign the order request via a duplicate order request to a second optimal commercial vehicle.

Some embodiments include a method for commercial vehicle dispatching for transportation of a product. In some embodiments, the method includes receiving an order request for the product from an order entry client, determining a product condition, and determining a vehicle condition of a first commercial vehicle and a vehicle condition of a second commercial vehicle. In some embodiments, the method further includes identifying, based on the product condition and the vehicle condition of the first commercial vehicle and the vehicle condition of the second commercial vehicle, an optimal commercial vehicle, the optimal commercial vehicle being either the first commercial vehicle or the second commercial vehicle. In some embodiments, the method further includes assigning the order request to the optimal commercial vehicle, and transmitting, to the optimal commercial vehicle, the order request.

In some embodiments, the method further includes receiving, from the optimal commercial vehicle, an order request deferral, identifying, in response to the order request deferral, a second optimal commercial vehicle, reassigning the order request to the second optimal commercial vehicle, and transmitting, to the second optimal commercial vehicle, the order request.

In some embodiments, the vehicle condition of the first commercial vehicle and the vehicle condition of the second commercial vehicle are each at least one selected from the group consisting of a physical rating, a rate of charge, a current location, a telecommunication provider, past performance data, and equipment data.

In some embodiments, the product condition includes at least one selected from the group consisting of a delivery time window, a pick-up time window, an equipment constraint, and a storage constraint.

In some embodiments, the method further includes monitoring and verifying a performance of the optimal commercial vehicle while the optimal commercial vehicle is assigned the order request.

In some embodiments, the method further includes unassigning the order request from the optimal commercial vehicle when the optimal commercial vehicle fails to comply with the product condition after a predetermined period of time.

In some embodiments, the method further includes retrieving information regarding a tank of the first commercial vehicle and a tank of the second commercial vehicle from a vehicle trailer/tank database.

In some embodiments, the information includes at least one selected from the group consisting of a trailer or tank content history, a gauge measurement of a tank, a location of the tank or trailer, and data regarding a product stored in the tank or trailer.

In some embodiments the method further includes verifying a location of the optimal commercial vehicle while the optimal commercial vehicle is assigned the order request.

In some embodiments, the method further includes recurrently assigning the order request via a duplicate order request to a second optimal commercial vehicle.

Some embodiments include a commercial vehicle dispatch system for transportation of a product. In some embodiments, the system includes a plurality of commercial vehicles, an order entry client, and a dispatch server configured to receive an order request for the product from the order entry client, determine a safety condition based on the product, and determine, based on the safety condition of the product, at least one of an optimal commercial vehicle from the plurality of commercial vehicles, wherein the at least one optimal commercial vehicle complies with the safety condition. In some embodiments, the dispatch server is further configured to assign the order request to the optimal commercial vehicle, and transmit, to the optimal commercial vehicle, the order request.

In some embodiments, the dispatch server is further configured to execute, after transmitting the order request to the optimal commercial vehicle, a verification action. In some embodiments, the verification action is used to verify that the optimal commercial vehicle maintains an order request compliance while the optimal commercial vehicle is assigned the order request.

In some embodiments, the verification action is at least one selected from the group consisting of a route verification, a photo verification, a stop limit, and a product exchange verification.

In some embodiments, the dispatch system is further configured to determine, based on the verification action, whether the optimal commercial vehicle is maintaining the order request compliance, and, in response to the optimal commercial vehicle failing to maintain the order request compliance, transmit a warning notice to a driver of the optimal commercial vehicle.

In some embodiments, the dispatch server is further configured to, after transmitting the warning notice and the optimal commercial vehicle continues to fail to maintain the order request compliance, perform at least one selected from the group consisting of denying submission of an invoice, and unassigning the order request from the optimal commercial vehicle.

In some embodiments, the safety condition is at least one selected from the group consisting of a certification type, a carried product history, an equipment requirement, and a carry time limit.

In some embodiments, the dispatch system further includes a vehicle trailer/tank database, wherein the vehicle trailer/tank database includes information regarding a trailer or tank of each commercial vehicle of the plurality of commercial vehicles.

In some embodiments, the information includes at least one selected from the group consisting of a trailer or tank content history, a gauge measurement of a tank, a location of the tank or trailer, and data regarding a product stored in the tank or trailer.

In some embodiments, the dispatch server is further configured to recurrently assign the order request via a duplicate order request to a second optimal commercial vehicle.

Some embodiments include a method of dispatch of a commercial vehicle for transportation of a product. In some embodiments, the method includes receiving an order request for the product from an order entry client, determining a safety condition based on the product, determining, based on the safety condition of the product, at least one of an optimal commercial vehicle from the plurality of commercial vehicles. In some embodiments, the at least one optimal commercial vehicle complies with the safety condition. In some embodiments, the method includes assigning the order request to the optimal commercial vehicle, and transmitting, to the optimal commercial vehicle, the order request.

In some embodiments, the method further includes executing, after transmitting the order request to the optimal commercial vehicle, a verification action, wherein the verification action is used to verify that the optimal commercial vehicle maintains an order request compliance while the optimal commercial vehicle is assigned the order request.

In some embodiments, the verification action is at least one selected from the group consisting of a route verification, a photo verification, a stop limit, and a product exchange verification.

In some embodiments, the method further includes determining, based on the verification action, whether the optimal commercial vehicle is maintaining the order request compliance, and, in response to the optimal commercial vehicle failing to maintain the order request compliance, transmitting a warning notice to a driver of the optimal commercial vehicle.

In some embodiments, the method further includes, after transmitting the warning notice and the optimal commercial vehicle continues to fail to maintain the order request compliance, performing at least one selected from the group consisting of denying submission of an invoice, and unassigning the order request from the optimal commercial vehicle.

In some embodiments the safety requirement condition is at least one selected from the group consisting of a certification type, a carried product history, an equipment requirement, and a carry time limit.

In some embodiments, determining the optimal commercial vehicle further includes retrieving information regarding a trailer or tank of each commercial vehicle of the plurality of commercial vehicles from a vehicle trailer/tank database.

In some embodiments, the information includes at least one selected from the group consisting of a trailer or tank content history, a gauge measurement of a tank, a location of the tank or trailer, and data regarding a product stored in the tank or trailer.

In some embodiments, the method further including recurrently assign the order request via a duplicate order request to a second optimal commercial vehicle.

Some embodiments include a commercial vehicle dispatch system for transportation of a product. In some embodiments, the system includes an order entry client, and a dispatch server configured to receive an order request for the product from the order entry client, the order request including a destination of the product. In some embodiments, the dispatch server is configured to assign a commercial vehicle to complete the order request, determine, based on an initial location of the product or the commercial vehicle and the destination of the product, a plurality of possible routes to the destination, determine a lowest cost route from the plurality of possible routes based on a route cost, assign the lowest cost route to the commercial vehicle, and verify that the commercial vehicle is following the lowest cost route while the commercial vehicle is assigned the order request by monitoring a location of the commercial vehicle and comparing the location to the lowest cost route.

In some embodiments, the dispatch server is further configured to calculate, after completion of the order request, a tax rebate based on an actual route of the commercial vehicle, and generate, based on the tax rebate, an invoice for the order request.

In some embodiments, the dispatch server is further configured to transmit, when the commercial vehicle fails to follow the lowest cost route, a warning notice, and, after transmitting the warning notice and the commercial vehicle continues to fail to follow the lowest cost route, perform at least one selected from the group consisting of denying submission of the invoice and unassigning the order request from the commercial vehicle.

In some embodiments, the route cost is based on at least one selected from the group consisting of a travel time, a mileage, and a road tax cost. In some embodiments, the route cost is based on a portion of each of the possible routes being on a public road and a leased road. In some embodiments, the dispatch server is further configured to define a plurality of geofences along the lowest cost route and determine that the commercial vehicle is following the lowest cost route by verifying that the commercial vehicle is within a particular geofence based on the location of the commercial vehicle.

In some embodiments, the route cost is based on a state in which the each of the possible routes runs through. In some embodiments, the dispatch server is further configured to select the commercial vehicle from a plurality of commercial vehicles based on a product condition. In some embodiments, the product condition is at least one selected from the group consisting of a delivery time window, a pick-up time window, an equipment constraint, and a storage constraint. In some embodiments, the dispatch server is further configured to select the commercial vehicle from a plurality of commercial vehicles based on a vehicle condition. In some embodiments, the vehicle condition includes at least one selected from the group consisting of a physical rating, a rate of charge, a current location, a telecommunication provider, past performance data, and equipment data.

Some embodiments include a method for dispatching a commercial vehicle for transportation of a product. In some embodiments, the method includes receiving an order request for the product from an order entry client, the order request including a destination of the product, assigning a commercial vehicle to complete the order request, determining, based on an initial location of the product or the commercial vehicle and the destination of the product, a plurality of possible routes to the destination, determining a lowest cost route from the plurality of possible routes based on a route cost, assigning the lowest cost route to the commercial vehicle, and verifying that the commercial vehicle is following the lowest cost route while the commercial vehicle is assigned the order request by monitoring a location of the commercial vehicle and comparing the location to the lowest cost route.

In some embodiments, the method further includes calculating, after completion of the order request, a tax rebate based on an actual route of the commercial vehicle, and generating, based on the tax rebate, an invoice for the order request.

In some embodiments, the method further includes transmitting, when the commercial vehicle fails to follow the lowest cost route, a warning notice, and after transmitting the warning notice and the commercial vehicle continues to fail to follow the lowest cost route, performing at least one selected from the group consisting of denying submission of the invoice and unassigning the order request from the commercial vehicle.

In some embodiments, the route cost is based on at least one selected from the group consisting of a travel time, a mileage, and a road tax cost. In some embodiments, the route cost is based on a portion of each of the possible routes being on a public road and a leased road.

In some embodiments, the method further includes defining a plurality of geofences along the lowest cost route and determining that the commercial vehicle is following the lowest cost route by verifying that the commercial vehicle is within a particular geofence based on the location of the commercial vehicle. In some embodiments, the route cost is based on a state in which the each of the possible routes runs through. In some embodiments, the method further includes selecting the commercial vehicle from a plurality of commercial vehicles based on a product condition.

In some embodiments, the product condition is at least one selected from the group consisting of a delivery time window, a pick-up time window, an equipment constraint, and a storage constraint. In some embodiments, the method further includes selecting the commercial vehicle from a plurality of commercial vehicles based on a vehicle condition. In some embodiments, the vehicle condition includes at least one selected from the group consisting of a physical rating, a rate of charge, a current location, a telecommunication provider, past performance data, and equipment data.

Some embodiments include a computer program product in a computer readable medium for dispatching a commercial vehicle for transportation of a product. In some embodiments, the computer program product in a computer readable medium includes instructions for receiving an order request for the product from an order entry client, the order request including a destination of the product, assigning a commercial vehicle to complete the order request, determining, based on an initial location of the product or the commercial vehicle and the destination of the product, a plurality of possible routes to the destination, determining a lowest cost route from the plurality of possible routes based on a route cost, assigning the lowest cost route to the commercial vehicle, and verifying that the commercial vehicle is following the lowest cost route while the commercial vehicle is assigned the order request by monitoring a location of the commercial vehicle and comparing the location to the lowest cost route.

In some embodiments, the computer program product in a computer readable medium further includes instructions for calculating, after completion of the order request, a tax rebate based on an actual route of the commercial vehicle, and generating, based on the tax rebate, an invoice for the order request.

In some embodiments, the computer program product in a computer readable medium further includes instructions for transmitting, when the commercial vehicle fails to follow the lowest cost route, a warning notice, and after transmitting the warning notice and the commercial vehicle continues to fail to follow the lowest cost route, performing at least one selected from the group consisting of denying submission of the invoice and unassigning the order request from the commercial vehicle.

In some embodiments, the route cost is based on at least one selected from the group consisting of a travel time, a mileage, and a road tax cost. In some embodiments, the route cost is based on a portion of each of the possible routes being on a public road and a leased road.

In some embodiments, the computer program product in a computer readable medium further includes instructions for defining a plurality of geofences along the lowest cost route and determining that the commercial vehicle is following the lowest cost route by verifying that the commercial vehicle is within a particular geofence based on the location of the commercial vehicle. In some embodiments, the route cost is based on a state in which the each of the possible routes runs through. In some embodiments, the computer program product in a computer readable medium further includes instructions for selecting the commercial vehicle from a plurality of commercial vehicles based on a product condition.

In some embodiments, the product condition is at least one selected from the group consisting of a delivery time window, a pick-up time window, an equipment constraint, and a storage constraint. In some embodiments, the computer program product in a computer readable medium further includes instructions for selecting the commercial vehicle from a plurality of commercial vehicles based on a vehicle condition. In some embodiments, the vehicle condition includes at least one selected from the group consisting of a physical rating, a rate of charge, a current location, a telecommunication provider, past performance data, and equipment data.

Some embodiments include a computer program product in a computer readable medium for commercial vehicle dispatching for transportation of a product. In some embodiments, the computer program product in a computer readable medium includes instructions for receiving an order request for the product from an order entry client, determining a product condition, and determining a vehicle condition of a first commercial vehicle and a vehicle condition of a second commercial vehicle. In some embodiments, the computer program product in a computer readable medium further includes instructions for identifying, based on the product condition and the vehicle condition of the first commercial vehicle and the vehicle condition of the second commercial vehicle, an optimal commercial vehicle, the optimal commercial vehicle being either the first commercial vehicle or the second commercial vehicle. In some embodiments, the computer program product in a computer readable medium further includes instructions for assigning the order request to the optimal commercial vehicle, and transmitting, to the optimal commercial vehicle, the order request.

In some embodiments, the computer program product in a computer readable medium further includes instructions for receiving, from the optimal commercial vehicle, an order request deferral, identifying, in response to the order request deferral, a second optimal commercial vehicle, reassigning the order request to the second optimal commercial vehicle, and transmitting, to the second optimal commercial vehicle, the order request.

In some embodiments, the vehicle condition of the first commercial vehicle and the vehicle condition of the second commercial vehicle are each at least one selected from the group consisting of a physical rating, a rate of charge, a current location, a telecommunication provider, past performance data, and equipment data.

In some embodiments, the product condition includes at least one selected from the group consisting of a delivery time window, a pick-up time window, an equipment constraint, and a storage constraint.

In some embodiments, the computer program product in a computer readable medium further includes instructions for monitoring and verifying a performance of the optimal commercial vehicle while the optimal commercial vehicle is assigned the order request.

In some embodiments, the computer program product in a computer readable medium further includes instructions for unassigning the order request from the optimal commercial vehicle when the optimal commercial vehicle fails to comply with the product condition after a predetermined period of time.

In some embodiments, the computer program product in a computer readable medium further includes instructions for retrieving information regarding a tank of the first commercial vehicle and a tank of the second commercial vehicle from a vehicle trailer/tank database.

In some embodiments, the information includes at least one selected from the group consisting of a trailer or tank content history, a gauge measurement of a tank, a location of the tank or trailer, and data regarding a product stored in the tank or trailer.

In some embodiments the computer program product in a computer readable medium further includes instructions for verifying a location of the optimal commercial vehicle while the optimal commercial vehicle is assigned the order request.

In some embodiments, the computer program product in a computer readable medium further includes instructions for recurrently assigning the order request via a duplicate order request to a second optimal commercial vehicle.

Some embodiments include a computer program product in a computer readable medium of dispatch of a commercial vehicle for transportation of a product. In some embodiments, the computer program product in a computer readable medium includes instructions for receiving an order request for the product from an order entry client, determining a safety condition based on the product, determining, based on the safety condition of the product, at least one of an optimal commercial vehicle from the plurality of commercial vehicles. In some embodiments, the at least one optimal commercial vehicle complies with the safety condition. In some embodiments, the computer program product in a computer readable medium includes instructions for assigning the order request to the optimal commercial vehicle, and transmitting, to the optimal commercial vehicle, the order request.

In some embodiments, the computer program product in a computer readable medium further includes instructions for executing, after transmitting the order request to the optimal commercial vehicle, a verification action, wherein the verification action is used to verify that the optimal commercial vehicle maintains an order request compliance while the optimal commercial vehicle is assigned the order request.

In some embodiments, the verification action is at least one selected from the group consisting of a route verification, a photo verification, a stop limit, and a product exchange verification.

In some embodiments, the computer program product in a computer readable medium further includes instructions for determining, based on the verification action, whether the optimal commercial vehicle is maintaining the order request compliance, and, in response to the optimal commercial vehicle failing to maintain the order request compliance, transmitting a warning notice to a driver of the optimal commercial vehicle.

In some embodiments, the computer program product in a computer readable medium further includes instructions for, after transmitting the warning notice and the optimal commercial vehicle continues to fail to maintain the order request compliance, performing at least one selected from the group consisting of denying submission of an invoice, and unassigning the order request from the optimal commercial vehicle.

In some embodiments the safety requirement condition is at least one selected from the group consisting of a certification type, a carried product history, an equipment requirement, and a carry time limit.

In some embodiments, determining the optimal commercial vehicle further includes retrieving information regarding a trailer or tank of each commercial vehicle of the plurality of commercial vehicles from a vehicle trailer/tank database.

In some embodiments, the information includes at least one selected from the group consisting of a trailer or tank content history, a gauge measurement of a tank, a location of the tank or trailer, and data regarding a product stored in the tank or trailer.

In some embodiments, the computer program product in a computer readable medium further includes recurrently assign the order request via a duplicate order request to a second optimal commercial vehicle.

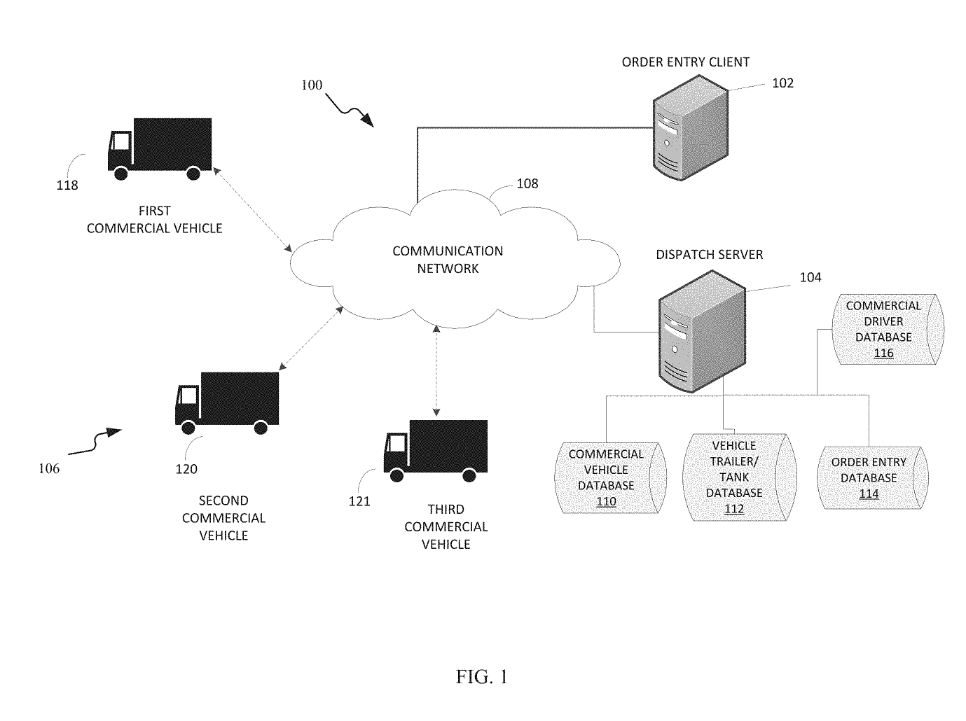

FIG. 1 illustrates a vehicle dispatch system 100 according to some embodiments. The vehicle dispatch system 100 includes an order entry client 102, a dispatch server 104, and a plurality of commercial vehicles 106. The order entry client 102, the dispatch server 104, and the plurality of commercial vehicles 106 communicate via a communication network 108.

The order entry client 102 is a server or software application on a server configured to receive and schedule order requests for transportation of a product or physical good. The order request may include information regarding the product, a pick-up location, and a delivery location. The information regarding the product may include the product type, a product quantity, and a product condition. In some embodiments, the order request also includes custom instructions from the customer or business that are considered in the transportation of the product. An order request is received, for example, by a customer or a business ordering the transport of one or more of a plurality of objects. Further, the order request may be created as a division of another order. For example, a first order request is created responsive to a business ordering a first plurality of product from a customer. A second order request and a third order request are created from the first order request responsive to customer ordering a second plurality of product from a first supplier and a third plurality of product from a second supplier, the second and third pluralities of product comprising a portion of the first plurality of product.

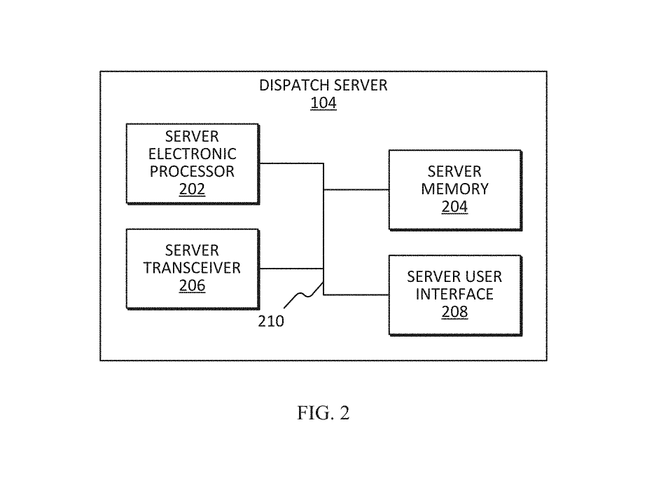

The dispatch server 104 is configured to assign order requests received from the order entry client 102 to one or more of the plurality of commercial vehicles 106 (as explained in more detail in regard to FIG. 2). The dispatch server 104 communicates with one or more server-based and/or cloud-based databases. For example, the dispatch server 104 communicates with a commercial vehicle database 110, a vehicle trailer/tank database 112, and an order entry database 114. The dispatch server 104 may also communicate with a commercial driver database 116. As illustrated in FIG. 1, the commercial vehicle database 110, the vehicle trailer/tank database 112, the order entry database 114, and the commercial driver database 116 are external to the dispatch server 104. However, in some embodiments one or more of the databases 110, 112, 114, and 116 (or portions thereof) may be stored in a memory internal to the dispatch server 104. Additionally, although illustrated as separate databases, one or more of the databases 110, 112, 114, and 116 (or portions thereof) may be combined into a single database.

The commercial vehicle database 110 contains information regarding each of the plurality of commercial vehicles. Such information may include, for example, physical specifications and limits, mileage, previously completed orders, and the like. The vehicle trailer/tank database 112 includes a trailer and/or tank content history of each of the plurality of commercial vehicles 106 within the commercial vehicle database 110. The vehicle trailer/tank database 112 also includes information regarding previous product(s) carried within a particular trailer and/or tank. In some embodiments, the vehicle trailer/tank database 112 includes information including gauge measurements of the tank, a location of the tank or trailer, and data regarding a product stored within the tank or trailer. The order entry database 114 stores and manages the order requests received from the order entry client 102. The commercial driver database 116 includes profiles of commercial vehicle drivers driving the commercial vehicles. Each profile includes information regarding a particular commercial vehicle driver. For example, each profile may include information regarding a certification level, a rate of charge, a telecommunication provider, and past performance data of a particular commercial vehicle driver.

The plurality of commercial vehicles 106 includes a first commercial vehicle 118, a second commercial vehicle 120, and a third commercial vehicle 121. Although three commercial vehicles 118, 120, and 121 are illustrated in FIG. 1, it should be understood that, the plurality of commercial vehicles 106 may include fewer or additional commercial vehicles. The plurality of commercial vehicles 106 may include manned vehicles, autonomous vehicles (for example, autonomous transport robots), or semi-autonomous vehicles. In some embodiments, the plurality of commercial vehicles 106 include airplanes, boats, drones, or any other type of vehicle capable of transporting a product from one location to another location.

The communication network 108 may be a wired network, a wireless network, or both. All or parts of the communication network 108 may be implemented using various networks, for example, a cellular network, the Internet, a Bluetooth™ network, a wireless local area network (for example, Wi-Fi), a wireless accessory Personal Area Networks (PAN), cable, an Ethernet network, satellite, a machine-to-machine (M2M) autonomous network, and a public switched telephone network. The order entry client 102, the dispatch server 104, the plurality of commercial vehicles 106, and the other various components of the vehicle dispatch system 100 communicate with each other over the communication network 108 using suitable wireless or wired communication protocols. In some embodiments, communications with other external devices (not shown) occur over the communication network 108.

FIG. 2 is a diagram of one example embodiment of the dispatch server 104. In the example illustrated, the dispatch server 104 includes a server electronic processor 202, server memory 204, a server transceiver 206, and a server user interface 208. The server electronic processor 202, the server memory 204, as well as the other various modules are coupled by a bus 210, or are coupled directly, by one or more additional control or data buses, or a combination thereof. In other embodiments, the dispatch server 104 may include fewer or additional components in configurations different from that illustrated in FIG. 2.

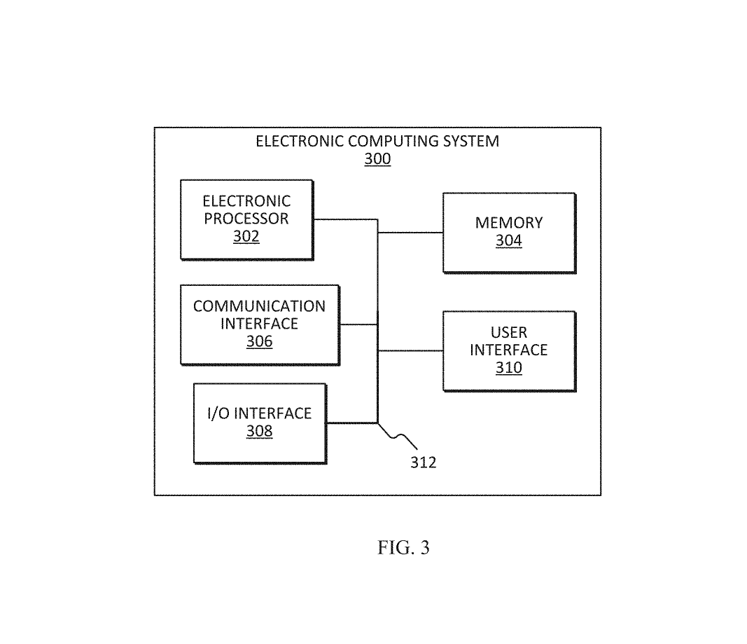

The server memory 204 stores program instructions and data. The server memory 204 may include combinations of different types of memory, including the various types of memory described below with respect to the memory 304 included in the electronic computing device 300 of FIG. 3. The server electronic processor 202 retrieves program instructions from the server memory 204 and executes the instructions to perform a set of functions including all or part of the methods described herein. The server transceiver 206 transmits signals to and receives signals from the plurality of transport vehicles 106, the order entry client 102, and other components included in the system 100, such as through the communication network 108 or directly. In some embodiments, signals include, for example, data, data packets, or any combination thereof. The server user interface 210 includes any combination of digital and analog input devices required to achieve a desired level of control for the dispatch server 104. For example, the server user interface 210 can include a computer having a display and input devices, a display, a keyboard, a mouse, speakers, and the like.

In some embodiments, the order entry client 102 and the databases 110, 112, 114, and 116 include components or combinations of different components, including all or some of the various components described above with respect to the dispatch server 104.

It should be understood in implementing the methods described in detail below, the dispatch server 104 may transmit an order request and related warnings/instructions to and receive information from a commercial vehicle through a dedicated software application or web-based application operating on an electronic computing device (for example, a cellphone or tablet computer).

For example, FIG. 3 illustrates an electronic computing device 300. As illustrated in FIG. 3, the electronic computing device 300 includes an electronic processor 302, a memory 304, a communication interface 306, and an input/output (I/O) interface 308. The electronic processor 302, the memory 304, the communication interface 306, as well as the other various modules are coupled by a bus 310. In some embodiments, the electronic processor 302, the memory 304, the communication interface 306, and the like are coupled together by one or more additional control or data buses, or a combination thereof. In alternate embodiments, the electronic computing device 300 may include fewer or additional components in configurations different from the configuration illustrated in FIG. 3.

It should be understood that the electronic computing device 300 may include additional components than those illustrated in FIG. 3 in various configurations and may perform additional functionality than the functionality described in the present application. Also, it should be understood that the functionality described herein as being performed by the electronic computing device 300 may be distributed among multiple devices, such as multiple servers, and may be provided through a cloud computing environment or accessible by components external to the system 100 via the communication network 108.

The electronic processor 302 may include a microprocessor, application-specific integrated circuit (ASIC), or another suitable electronic device. The electronic processor 302 is configured to retrieve from the order entry client 102 and the dispatch server 104 and execute, among other things, software related to the processes and methods described herein.

The memory 304 includes a non-transitory, computer-readable storage medium. As used herein, the term “non-transitory computer readable medium” comprises all computer-readable media except for a transitory, propagating signal. Accordingly, a non-transitory computer-readable medium may include, for example, a hard disk, a CD-ROM, an optical storage device, a magnetic storage device, a ROM (Read Only Memory), a RAM (Random Access Memory), a register memory, a processor cache, or any combination thereof.

The communication interface 306 is configured for communicating signals over the communications network 108 and, optionally, one or more additional wired or wireless communication networks or connections. In some embodiments, signals include, for example, data, data packets, or any combination thereof. The communication interface 306 may include a transceiver coupled to the I/O interface 308 (not shown). The transceiver may be, for example, a Wi-Fi or Ethernet transceiver. In some embodiments, the transceiver includes separate transmitters and receivers.

The I/O interface 308 operates to receive input from, for example, a user of the electronic computing device 300, to provide system output, or a combination of both. The I/O interface 308 obtains information and signals from, and provides information and signals to, (for example, over one or more wired and/or wireless connections) devices both within and outside the electronic computing system. Input may be provided via, for example, a keypad, a microphone, soft keys, icons, soft buttons, a scroll ball, buttons, and the like. System output may be provided via a display screen 312. The display screen 312 is a suitable display device such as, for example, a liquid crystal display (LCD) touch screen, or an organic light-emitting diode (OLED) touch screen. The I/O interface 308 may include a graphical user interface (GUI) (for example, generated by the electronic processor 107, from instructions and data stored in the memory 304 or received from the dispatch server 104, and presented on the display screen 312) that enables a user to interact with the electronic computing device 300. In alternative embodiments, the I/O interface 308 includes a push-to-talk (PTT) button for activating a two-way radio modem (not shown), which button may be implemented, for example, as a physical switch or by using a soft key or icon in the graphical user interface on the display screen 312.

The I/O interface 308 may also communicate with additional systems and components within one or more of the plurality of commercial vehicles 106 and/or additional components and systems within and outside the electronic computing device 300. For example, the I/O interface 308 may communicate with one or more sensors (not shown) configured to detect various conditions of the each of the plurality of vehicles 106. In some embodiments, the plurality of sensors include location sensors, environmental sensors, movement sensors, audio sensors, electrical sensors, or any combination thereof. Location sensors (for example, global positioning system (GPS) sensors) determine an absolute or relative location of each of the commercial vehicles 118, 120, and 121. In some embodiments, location sensors determine the location periodically. Alternatively or in addition, location sensors determine the location in response to receiving a request (for example, via the transceiver). For example, the dispatch server 104 sends a request signal to the electronic computing device 300 requesting a location of the commercial vehicle. In response, the electronic computing device 300 determines a current (or last known) location of the commercial vehicle, via location sensors, and transmits the location to the recipient or sender. In some embodiments, the electronic computing device 300 determines the location based at least in part on one or more location signals received via the transceiver or, in some embodiments, through a GPS system of the commercial vehicle. In some embodiments, the I/O interface 308 may include a speaker (not shown) to provide an audible system output.

The electronic computing device 300 may be a personal computing device (for example, a desktop computer, a laptop computer, a terminal, a tablet computer, a smart telephone, a wearable device, or the like) that includes similar components as the electronic computing device 300. In some embodiments, the electronic computing device 300 is used by a user to access functionality provided by the dispatch server 104 via the communication network 108. The electronic computing device 300 may access the functionality provided by the dispatch server 104 using a web-browser, a dedicated software client/application, or the like.

The functionality provided by the dispatch server 104 to the electronic computing device 300 may include a communication or messaging service, such as an email messaging service, an instant messaging service, or the like. For example, the dispatch server 104 may provide a series of electronic task services, contact management services, and the like. For example, in some embodiments, the dispatch server 104 provides a series of electronic task instructions based on an order request. Such task instructions may also include route directions to a pick-up location and/or destination. The electronic task instructions may be communicated/displayed to a user of the electronic computing device 300, for example, via the user interface.

As described in detail below, the system 100 operates to receive and process information regarding order requests and information regarding the commercial vehicles 106 and the product of the order request. Using this information, the system 100, in particular the dispatch server 104 dispatches one or more commercial vehicles to fulfill an order request. For example, order requests are received from a client at the dispatch server 104, processed as described in detail below, and dispatch instructions are transmitted to one or more of the commercial vehicles 106.

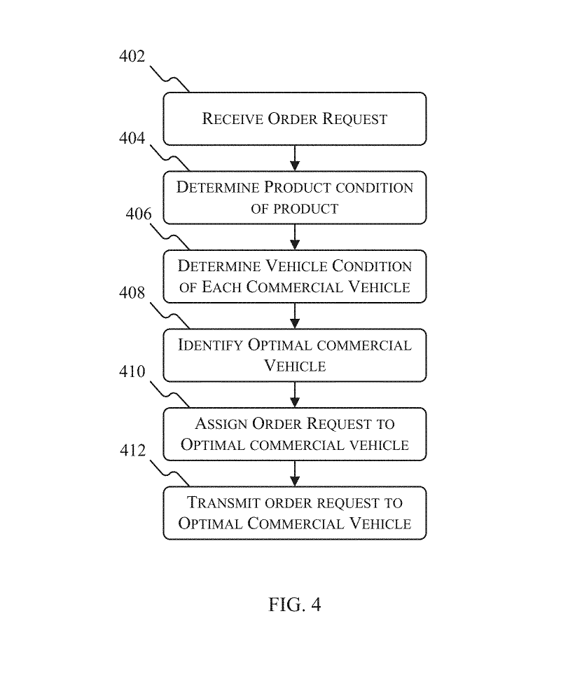

FIG. 4 is a flowchart illustrating an example method 400 of commercial vehicle dispatching for transportation of a product. In the example illustrated, the method 400 includes the dispatch server 104 receiving an order request (at block 402). In some embodiments, the dispatch server 104 receives the order request over the communication network 108 from the order entry client 102. The dispatch server 104 determines a product condition based on the order request (block 404). The product condition is one or more particular requirements for the product of the order request. The product condition may be, for example, a delivery time window, a pick-up time window, an equipment constraint, and a storage constraint. The delivery time window is a period of time in which the product is able to be delivered. Likewise, the pick-up time window is a period of time in which the product is able to be picked up. In some embodiments, both the delivery time window and the pick-up time window are defined as a period between a first local time to a second local time on a specific date. The equipment constraint is any physical requirement for transit of the product. For example, the equipment constraint may call for a particular instrument for containing or securing the product. The equipment constraint may also be a requirement of the trailer/tank of the commercial vehicle such as a physical rating or requirement (for example, a maximum weight capacity). A storage constraint is a requirement for maintaining the product during transit (for example, a storage temperature, a humidity level, a pressure level, fragility requirements, motion requirements, and the like).

At block 406, the dispatch server 104 determines a vehicle condition of each of the plurality of commercial vehicles 106. The vehicle condition includes one or more qualities of a commercial vehicle and a driver of the commercial vehicle. In some embodiments, the vehicle condition includes a physical rating, a rate of charge, a current location, a telecommunication provider, past performance data, and equipment data.

At block 408, the dispatch server 104 identifies, based on the product condition and the vehicle condition, an optimal commercial vehicle from the plurality of vehicles 106. Specifically, the dispatch server 104 determines a commercial vehicle from the plurality of commercial vehicles 106 that best meets the product condition based on the vehicle condition. The dispatch server 104 may further evaluate whether the vehicle condition of the commercial vehicle meet additional conditions based on the order request. For example, when there is a possibility that the destination of the product may be changed during transit of the product, the communication provider of the commercial vehicle may be considered to ensure the commercial vehicle may be reachable during transit.

At block 408, the dispatch server 104 assigns the order request to the optimal commercial vehicle. The assignment of the order request may be stored in the order entry database 114. At block 410, the dispatch server 104 transmits the order request to the optimal commercial vehicle.

In some embodiments, when the optimal vehicle receives the order request from the dispatch server 104, the order request may be accepted or denied by the optimal vehicle. The optimal vehicle may deny the order request before or during execution of the order request. The optimal vehicle may transmit an order request deferral to the dispatch server 104. The denied order request may include one or more reasons as to why the order request was denied, for example an equipment-related, operator-related, or weather-related reason. When the dispatch server 104 receives an order request deferral, the dispatch server 104 may make the order request available to be reassigned to a second optimal commercial vehicle. In some embodiments, the dispatch server 104 may automatically identify a second optimal vehicle based on the product condition and the vehicle condition and reassign the order request, after receiving an order request deferral, to a second optimal commercial vehicle. The dispatch server 104 then transmits the order request to the second optimal vehicle. The dispatch server 104 may then update the order entry database 114 accordingly.

When the order request is received/accepted by the optimal commercial vehicle, the dispatch server 104 verifies a performance of the optimal commercial vehicle while the optimal commercial vehicle is assigned the order request. Specifically, the dispatch server 104 verifies that the optimal commercial vehicle picks up and drops off the amount of the product at the pick-up and destinations specified in the order request within a predetermined time. The dispatch server 104 may verify the performance based on a location of the optimal commercial vehicle (obtained, for example, via a global positioning/navigation system of the commercial vehicle and/or a portable electronic device), a confirmation from the driver of the optimal commercial vehicle, a confirmation from the pick-up location, and a confirmation from the destination. In some embodiments, the dispatch server 104 also periodically requests from and/or determines an estimated time of arrival (ETA) of the optimal commercial vehicle.

When the dispatch server 104 determines that the performance of the optimal commercial vehicle fails to comply with one or more of the product conditions of the order request, the dispatch server 104 may transmit a warning notice to the optimal commercial vehicle. The warning notice specifies the product condition that the optimal commercial vehicle and/or the driver of the optimal commercial vehicle fails to comply with. In some embodiments, the warning notice may also include an instruction to correct the failure to comply with the product condition. When the dispatch server 104, after transmitting the warning notice, determines after a predetermined time that the performance of the optimal commercial vehicle continues to fail to comply with the product condition, the dispatch server 104 unassigns the order request from the optimal commercial vehicle. The dispatch server 104 may then identify a second optimal commercial vehicle and reassign the order request to the second optimal commercial vehicle. The dispatch server 104 then transmits the order request to the second optimal commercial vehicle and verifies the performance of the second optimal commercial vehicle while the order request is assigned to the second optimal commercial vehicle.

The dispatch server 104 is further configured to update the vehicle trailer/tank database 112 when a product exchange occurs. The product exchange may be when any amount of the product is picked up or dropped off during execution of the order request. The vehicle trailer/tank database 112 updates the information regarding the trailer/tank of the optimal commercial vehicle to include data regarding the product the optimal commercial vehicle is carrying and/or delivers in response to the order request. The information may automatically be received or attained by the dispatch server 104. For example, when the optimal commercial vehicle is hauling a tank, the vehicle trailer/tank database 112 may be updated based on a gauge measurement of the tank. In some embodiments, the dispatch server 104 requests the information and any related documentation from the driver of the optimal commercial vehicle via an electronic request.

When the optimal commercial vehicle completes the order request, the dispatch server 104 may generate a product report based on the order request and information collected to verify the performance of the optimal commercial vehicle. The product report may be compared to a manually submitted invoice (an invoice created by a driver of the commercial vehicle). When there is a discrepancy between the two or when it is determined that the optimal commercial vehicle failed to maintain an order compliance while the optimal commercial vehicle was assigned the order request, the dispatch server 104 may deny a submission of the manual invoice. In some embodiments, the dispatch server 104 may recurrently assign the order request via a duplicate order request to another optimal commercial vehicle. The duplicate request may be assigned to one or more additional optimal commercial vehicles during or upon completion of the order request by the optimal commercial vehicle the order request is assigned to.

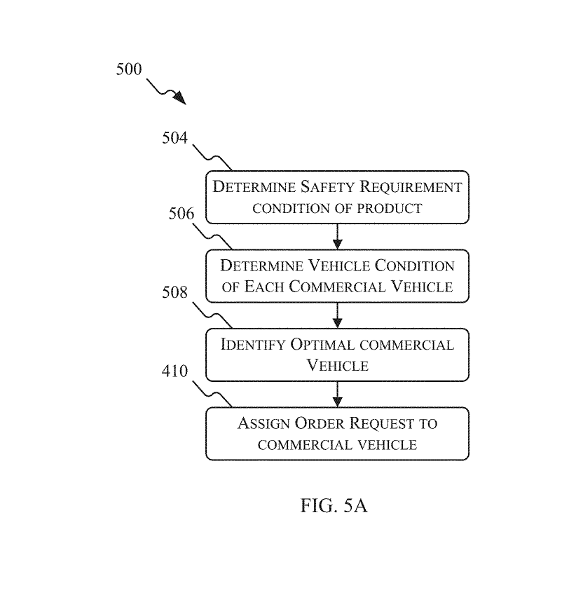

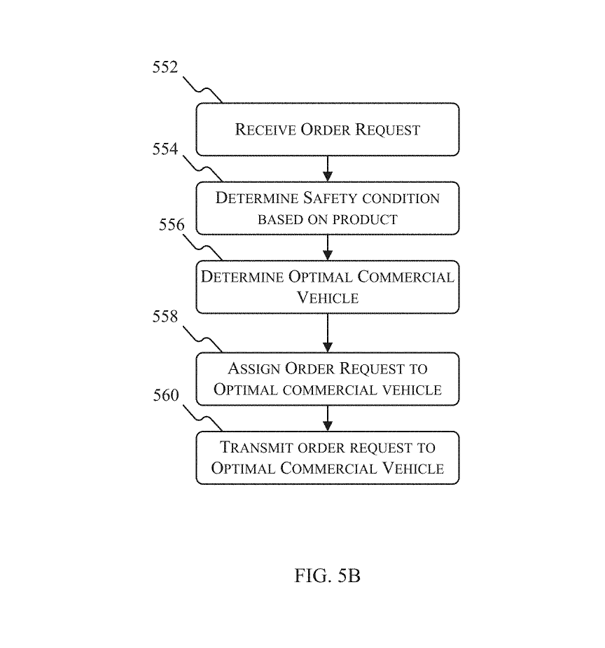

For particular products, certain laws and regulations may be applicable to ensure safe transit and handling of the product. In such cases, it may be necessary to consider and verify a safety compliance of a commercial vehicle assigned to fulfill a particular order request. Accordingly, in some embodiments, blocks 404, 406, and 408 of the method 400 may be replaced by or executed in conjunction with blocks 504, 506, and 508 of method 500 illustrated in FIG. 5A described in more detail below.

FIG. 5A illustrates a method 500 of commercial vehicle dispatching for maintaining a safety compliance during transportation of a product. At block 504, the dispatch server 104 determines a safety condition of the product. The safety condition may be one or more of a certification type, a carried product history, an equipment requirement, and a carry time limit. The certification type may be a required validation or license that a commercial vehicle (or driver of the vehicle) is required to have when handling a particular product. The carried product history may be necessary in the case that contamination of the product with certain other products may produce a hazard. For example, a tank of a commercial vehicle previously filled with propane should not be filled with compressed natural gas because the contamination between the two may cause a chemical reaction. The equipment requirement may be a condition that one or more particular tool or instrument needs to be carried with the product. This may be in case of an emergency situation. For example, the equipment requirement may be that respirator equipment or a certain class of fire extinguisher needs to be on hand while fulfilling the order request. A carry time limit is a maximum time period in which the product may be carried. In some embodiments, the safety condition is based on one or more applicable laws and/or regulations.

At block 506, the dispatch server 104 determines a vehicle condition of each of the plurality of commercial vehicles 106. The vehicle condition includes one or more qualities of a commercial vehicle and a driver of the commercial vehicle. In some embodiments, the vehicle condition includes a certification level, a compliance level, a rate of charge, a current location, a telecommunication provider, past performance data, and equipment data. The compliance level is a validation verification that particular qualities of the commercial vehicle and, in some embodiments, the driver of the commercial vehicle, meet a standard requirement (for example, a maximum weight capacity of the commercial vehicle or years of experience of the driver).

At block 508, the dispatch server 104 identifies, based on the safety condition of the product and the vehicle condition, at least one of an optimal commercial vehicle that each comply with the safety condition. Specifically, the dispatch server 104 determines one or more of a commercial vehicle from the plurality of commercial vehicles 106 that best meets the safety condition based on the vehicle condition. The dispatch server 104 may determine the compliance by referring to the commercial vehicle database 110, the vehicle trailer/tank database 112, and/or the commercial driver database 116. As similarly described above in regard to block 408 of the method 400 of FIG. 4, the dispatch server 104 may further evaluate whether the vehicle condition of the commercial vehicle meet additional conditions based on the order request. The method 500 may then continue at block 410 of the method 400 illustrated in FIG. 4, where the dispatch server 104 assigns the order request to an optimal commercial vehicle.

In some embodiments, the method 500 may be performed independent of the method 400. FIG. 5B illustrates a method 550 of commercial vehicle dispatching for maintaining a safety compliance during transportation of a product. Some of the blocks described herein in regard to the method 550 may be performed similarly as those laid out above in regard to the method 400 of FIG. 4 and the method 500 of FIG. 5A.

At block 552, the dispatch server 104 receives an order request. At block 554, the dispatch server 104 determines a safety condition based on the product of the order request. At block 556, the dispatch server 104 determines, based on the safety condition of the product, at least one of an optimal commercial vehicle from the plurality of commercial vehicles 106, wherein the at least one optimal commercial vehicle complies with the safety condition. At block 558, the dispatch server 104 assigns the order request to the optimal commercial vehicle and, at block 560, the dispatch server 104 transmits, to the optimal commercial vehicle, the order request.

In some embodiments, the dispatch server 104 executes, after transmitting the order request to the optimal commercial vehicle, a verification action, wherein the verification action is used to verify that the commercial vehicle maintains an order request compliance while the commercial vehicle is assigned the order request. The verification action may include one or more selected from the group consisting of a route verification, a photo verification, a stop limit, and a product exchange verification. The verification action may include transmitting an electronic instruction to an electronic communication device within the optimal commercial vehicle. The electronic instruction may include an instruction to the driver of the optimal commercial vehicle to provide a document (for example, a photo) to execute the particular kind of verification action (for example, for the photo verification). In some embodiments, the verification action includes receiving location information from an electronic communication device (for example, the electronic computing device 300 of FIG. 3) integrated into or located within the optimal commercial vehicle (for example, a cell phone, a commercial electronic logging device, a GPS system, and the like).

In some embodiments, the dispatch server 104 is further configured to, in response to the optimal commercial vehicle failing to maintain the order request compliance, transmit a warning notice to the driver of the optimal commercial vehicle. In some embodiments, the dispatch server 104 may store an incident record including information regarding the warning notice within one or more of the databases 110, 112, 114, and 116. The dispatch server 104 may also be configured to transmit a notification of the warning notice to a dispatch center and/or the client who originally sent the order request.

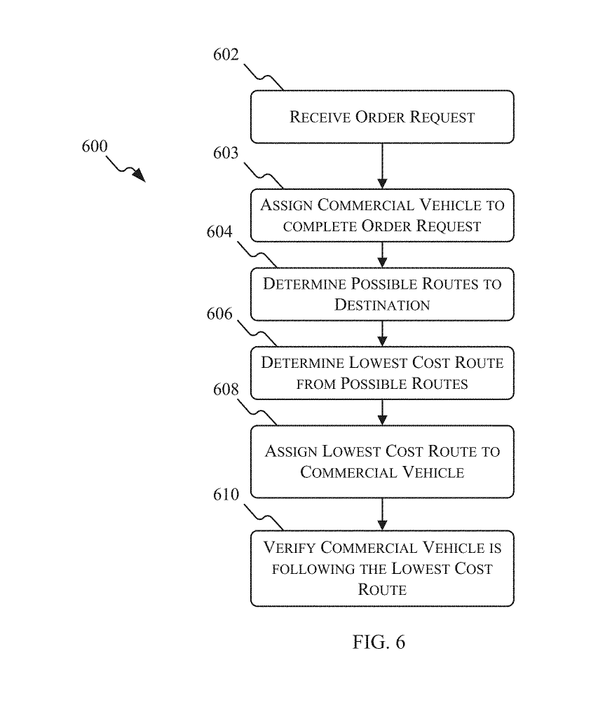

In some embodiments, the dispatch server 104 is configured to determine a lowest cost route from the pick-up location and the destination specified in an order request. The dispatch server 104 may also verify that the optimal commercial vehicle assigned the order request follows the lowest cost route. FIG. 6A illustrates a method 600 of commercial vehicle dispatching for determining and verifying the optimal commercial vehicle follows the lowest cost route.

At block 602, the dispatch server 104 receives an order request for the product from the order entry client 102, the order request including a destination of the product. At block 603, a commercial vehicle (for example, the optimal commercial vehicle determined at block 408 of the method 400) is assigned to complete the order request. At block 604, the dispatch server 104 determines based on the destination and an initial location of product or of the optimal commercial vehicle, a plurality of possible routes to the destination. At block 606, the dispatch server 104 determines a lowest cost route from the plurality of routes based on a route cost. The route cost may be based on one or more of a travel time, a mileage, and a road tax cost. In some embodiments, the route cost may be based on a portion of each of the possible routes being on a public road and a leased road. The dispatch server 104 may also determine the route cost based on a state in which each of the possible routes runs through. At block 608, the lowest cost route is assigned to the optimal commercial vehicle. Information regarding the lowest cost route may be stored within a database of the dispatch server 104, for example in the order entry database 114.

While the order request is assigned to the optimal commercial vehicle, at block 610 the dispatch server 104 verifies that the optimal commercial vehicle is following the lowest cost route by monitoring a location of the optimal commercial vehicle and comparing the location to the lowest cost route. The location of the optimal commercial vehicle may be attained by the dispatch server 104, for example, via the global positioning system device within the optimal commercial vehicle. In some embodiments, the dispatch server 104 is configured to define a plurality of geofences along the lowest cost route. The dispatch server 104 may then determine that the optimal commercial vehicle is following the lowest cost route by verifying that the driver is within a particular geofence based on the location of the optimal commercial vehicle.

In some embodiments, the dispatch server 104 is further configured to calculate, after the optimal commercial vehicle completes the order request, a tax rebate based on an actual route of the optimal commercial vehicle. The dispatch server 104 may then generate an invoice for the order request based on the tax rebate.

The methods described herein may be implemented in software, hardware, or a combination thereof, in different embodiments. In addition, the order of the blocks of the methods may be changed, and various elements may be added, reordered, combined, omitted, modified, etc. Various modifications and changes may be made as would be obvious to a person skilled in the art having the benefit of this disclosure. The various embodiments described herein are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the exemplary configurations may be implemented as a combined structure or component. These and other variations, modifications, additions, and improvements may fall within the scope of embodiments as defined in the claims that follow.

What is claimed is:

1. A commercial vehicle dispatch system for transportation of a product, the system comprising:
an order entry client; and
a dispatch server configured to:
receive an order request for the product from the order entry client, the order request including a destination of the product,
assign a commercial vehicle to complete the order request,
determine, based on an initial location of the product or the commercial vehicle and the destination of the product, a plurality of possible routes to the destination,
determine a lowest cost route from the plurality of possible routes based on a route cost,
assign the lowest cost route to the commercial vehicle,
verify that the commercial vehicle is following the lowest cost route while the commercial vehicle is assigned the order request by monitoring a location of the commercial vehicle and comparing the location to the lowest cost route,
calculate, after completion of the order request, a tax rebate based on an actual route of the commercial vehicle,
generate, based on the tax rebate, an invoice for the order request,
transmit, when the commercial vehicle fails to follow the lowest cost route, a warning notice, and
after transmitting the warning notice and the commercial vehicle continues to fail to follow the lowest cost route, perform at least one selected from the group consisting of denying submission of the invoice and unassigning the order request from the commercial vehicle.

2. The system of claim 1, wherein the route cost is based on at least one selected from the group consisting of a travel time, a mileage, and a road tax cost.

3. The system of claim 1, wherein the route cost is based on a portion of each of the possible routes being on a public road and a leased road.

4. The system of claim 1, wherein the dispatch server is further configured to define a plurality of geofences along the lowest cost route and determine that the commercial vehicle is following the lowest cost route by verifying that the commercial vehicle is within a particular geofence based on the location of the commercial vehicle.

5. The system of claim 1, wherein the route cost is based on a state in which the each of the possible routes runs through.

6. The system of claim 1, wherein the dispatch server is further configured to select the commercial vehicle from a plurality of commercial vehicles based on a product condition, and the product condition is at least one selected from the group consisting of a delivery time window, a pick-up time window, an equipment constraint, and a storage constraint.

7. The system of claim 1, wherein the dispatch server is further configured to select the commercial vehicle from a plurality of commercial vehicles based on a vehicle condition, and the vehicle condition includes at least one selected from the group consisting of a physical rating, a rate of charge, a current location, a telecommunication provider, past performance data, and equipment data.

8. A method for commercial vehicle dispatching for transportation of a product, the method comprising:
receiving an order request for the product from an order entry client;
determining a product condition;
determining a vehicle condition of a first commercial vehicle and a vehicle condition of a second commercial vehicle;
identifying, based on the product condition and the vehicle condition of the first commercial vehicle and the vehicle condition of the second commercial vehicle, an optimal commercial vehicle, the optimal commercial vehicle being either the first commercial vehicle or the second commercial vehicle;
assigning the order request to the optimal commercial vehicle; and
transmitting, to the optimal commercial vehicle, the order request.

9. The method of claim 8, the method further comprising:
receiving, from the optimal commercial vehicle, an order request deferral;
identifying, in response to the order request deferral, a second optimal commercial vehicle;
reassigning the order request to the second optimal commercial vehicle; and
transmitting, to the second optimal commercial vehicle, the order request.

10. The method of claim 8, wherein the vehicle condition of the first commercial vehicle and the vehicle condition of the second commercial vehicle are each at least one selected from the group consisting of a physical rating, a rate of charge, a current location, a telecommunication provider, past performance data, and equipment data.

11. The method of claim 8, wherein the product condition includes at least one selected from the group consisting of a delivery time window, a pick-up time window, an equipment constraint, and a storage constraint.

12. The method of claim 8, the method further comprising:
monitoring and verifying a performance of the optimal commercial vehicle while the optimal commercial vehicle is assigned the order request; and
unassigning the order request from the optimal commercial vehicle when the optimal commercial vehicle fails to comply with the product condition after a predetermined period of time.

13. The method of claim 8, the method further comprising:
retrieving information regarding a tank of the first commercial vehicle and a tank of the second commercial vehicle from a vehicle trailer/tank database, wherein the information includes at least one selected from the group consisting of a trailer or tank content history, a gauge measurement of a tank, a location of the tank or trailer, and data regarding a product stored in the tank or trailer; and
verifying a location of the optimal commercial vehicle while the optimal commercial vehicle is assigned the order request.

14. The method of claim 8, the method further comprising recurrently assigning the order request via a duplicate order request to a second optimal commercial vehicle.

15. A computer program product in a computer-readable medium for commercial vehicle dispatching for transportation of a product, the computer program product in a computer-readable medium comprising instructions, which, when executed, cause a processor of a dispatch server to perform:
receiving an order request for the product from an order entry client;
determining a product condition;
determining a vehicle condition of a first commercial vehicle and a vehicle condition of a second commercial vehicle;
identifying, based on the product condition and the vehicle condition of the first commercial vehicle and the vehicle condition of the second commercial vehicle, an optimal commercial vehicle, the optimal commercial vehicle being either the first commercial vehicle or the second commercial vehicle;
assigning the order request to the optimal commercial vehicle; and
transmitting, to the optimal commercial vehicle, the order request.

16. The computer program product in a computer-readable medium of claim 8, the computer program product in a computer-readable medium further comprising instructions, which, when executed, cause a processor of a dispatch server to perform:
receiving, from the optimal commercial vehicle, an order request deferral;
identifying, in response to the order request deferral, a second optimal commercial vehicle;
reassigning the order request to the second optimal commercial vehicle; and
transmitting, to the second optimal commercial vehicle, the order request.

17. The computer program product in a computer-readable medium of claim 8, wherein the vehicle condition of the first commercial vehicle and the vehicle condition of the second commercial vehicle are each at least one selected from the group consisting of a physical rating, a rate of charge, a current location, a telecommunication provider, past performance data, and equipment data.

18. The computer program product in a computer-readable medium of claim 8, wherein the product condition includes at least one selected from the group consisting of a delivery time window, a pick-up time window, an equipment constraint, and a storage constraint.

19. The computer program product in a computer-readable medium of claim 8, the computer program product in a computer-readable medium further comprising instructions, which, when executed, cause a processor of a dispatch server to perform:
monitoring and verifying a performance of the optimal commercial vehicle while the optimal commercial vehicle is assigned the order request; and
unassigning the order request from the optimal commercial vehicle when the optimal commercial vehicle fails to comply with the product condition after a predetermined period of time.

20. The computer program product in a computer-readable medium of claim 8, the computer program product in a computer-readable medium further comprising instructions, which, when executed, cause a processor of a dispatch server to perform:
retrieving information regarding a tank of the first commercial vehicle and a tank of the second commercial vehicle from a vehicle trailer/tank database, wherein the information includes at least one selected from the group consisting of a trailer or tank content history, a gauge measurement of a tank, a location of the tank or trailer, and data regarding a product stored in the tank or trailer;
verifying a location of the optimal commercial vehicle while the optimal commercial vehicle is assigned the order request; and
recurrently assigning the order request via a duplicate order request to a second optimal commercial vehicle.
